(19) United States
(12) Patent Application Publication
(10) Pub. No.: US 2015/0049737 A1
(43) Pub. Date: Feb. 19, 2015

(54) MEASUREMENT REPORTING WHEN COMMUNICATING WITH WEAK SERVING CELL

(71) Applicant: QUALCOMM Incorporated, San Diego, CA (US)

(72) Inventors: Ming YANG, San Diego, CA (US); Tom CHIN, San Diego, CA (US)

(73) Assignee: QUALCOMM Incorporated, San Diego, CA (US)

(21) Appl. No.: 13/970,404

(22) Filed: Aug. 19, 2013

(51) Int. Cl. H04W 36/30

(52) U.S. Cl. CPC H04W 36/30
USPC 370/332

(57) ABSTRACT

A process includes transmitting a measurement report for inter/intra frequency handover when certain conditions are met. The first condition occurs when a serving cell signal strength of a serving cell in a first radio access technology (RAT) is below a first absolute threshold. The second condition occurs when a neighbor cell signal strength of a neighbor cell also in the first RAT is above the serving cell signal strength by a predetermined first amount. The third condition occurs when the neighbor cell signal strength is above a second absolute threshold.

### TECHNICAL FIELD

Aspects of the present disclosure relate generally to wireless communication systems, and more particularly, to measurement reporting when communicating with a serving weak cell.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes transmitting a measurement report for inter/intra frequency handover when certain conditions are met. The first condition occurs when a serving cell signal strength of a serving cell in a first radio access technology (RAT) is below a first absolute threshold. The second condition occurs when a neighbor cell signal strength of a neighbor cell also in the first RAT is above the serving cell signal strength by a predetermined first amount. The third condition occurs when the neighbor cell signal strength is above a second absolute threshold.

Another aspect discloses an apparatus for wireless communication including means for transmitting a measurement report for inter/intra frequency handover when certain conditions are met. The first condition occurs when a serving cell signal strength of a serving cell in a first RAT is below a first absolute threshold. The second condition occurs when a neighbor cell signal strength of a neighbor cell also in the first RAT is above the serving cell signal strength by a predetermined first amount. The third condition occurs when the neighbor cell signal strength is above a second absolute threshold. The apparatus also includes means for delaying transmission of the measurement report for inter/intra frequency handover when the neighbor cell signal strength is below the second absolute threshold. The first absolute threshold and the second absolute threshold may also be functions of a target cell signal strength of a target cell in a second RAT and also functions of threshold settings signaled by a network for the first RAT and the second RAT.

In another aspect, a computer program product for wireless communication in a wireless network having a non-transitory computer-readable medium is disclosed. The computer readable medium has non-transitory program code recorded thereon which, when executed by the processor(s), causes the processor(s) to perform operations of transmitting a measurement report for inter/intra frequency handover when certain conditions are met. The first condition occurs when a serving cell signal strength of a serving cell in a first RAT is below a first absolute threshold. The second condition occurs when a neighbor cell signal strength of a neighbor cell also in the first RAT is above the serving cell signal strength by a predetermined first amount. The third condition occurs when the neighbor cell signal strength is above a second absolute threshold. The program code also causes the processor(s) to delay transmission of the measurement report for inter/intra frequency handover when the neighbor cell signal strength is below the second absolute threshold. The first absolute threshold and the second absolute threshold may also be functions of a target cell signal strength of a target cell in a second RAT and also functions of threshold settings signaled by a network for the first RAT and the second RAT.

Another aspect discloses a wireless communication apparatus having a memory and at least one processor coupled to the memory. The processor(s) is configured to transmit a measurement report for inter/intra frequency handover when certain conditions are met. The first condition occurs when a serving cell signal strength of a serving cell in a first RAT is below a first absolute threshold. The second condition occurs when a neighbor cell signal strength of a neighbor cell also in the first RAT is above the serving cell signal strength by a predetermined first amount. The third condition occurs when the neighbor cell signal strength is above a second absolute threshold. The processor(s) is also configured to delay transmission of the measurement report for inter/intra frequency handover when the neighbor cell signal strength is below the second absolute threshold. The first absolute threshold and the second absolute threshold may also be functions of a target cell signal strength of a target cell in a second RAT and also functions of threshold settings signaled by a network for the first RAT and the second RAT.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 illustrates a network with RATs having cells according to aspects of the present disclosure.

FIG. 6 is a block diagram illustrating a wireless communication method for transmission of measurement reports for inter/intra frequency handover according to aspects of the present disclosure.

FIG. 7 is a block diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

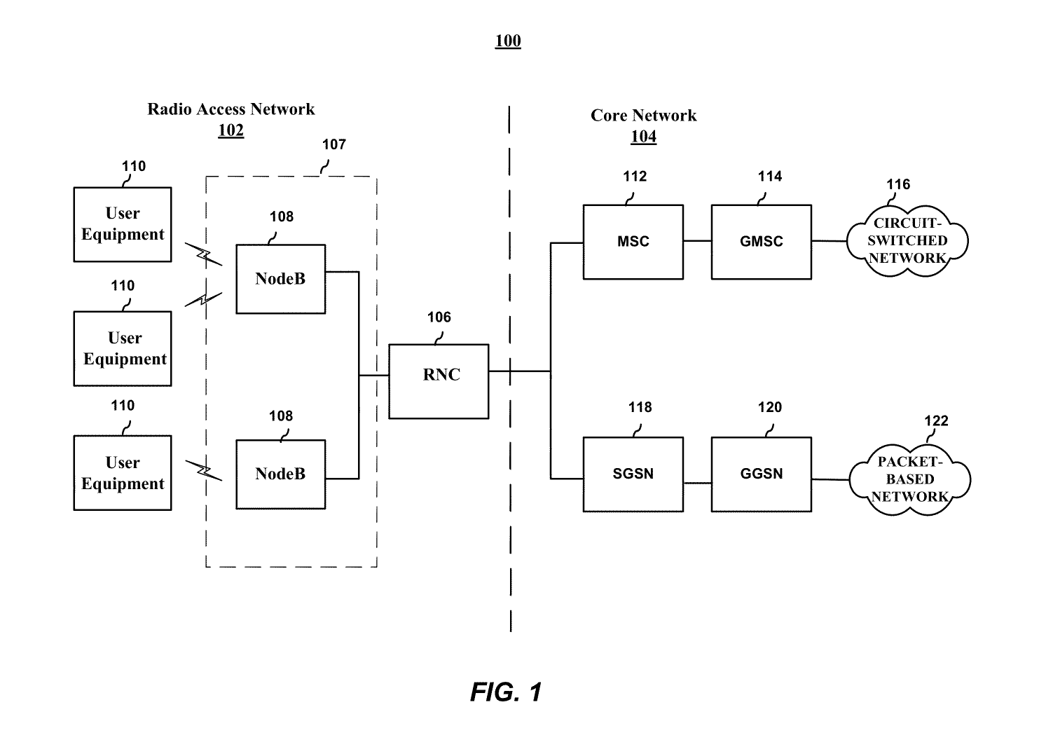

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

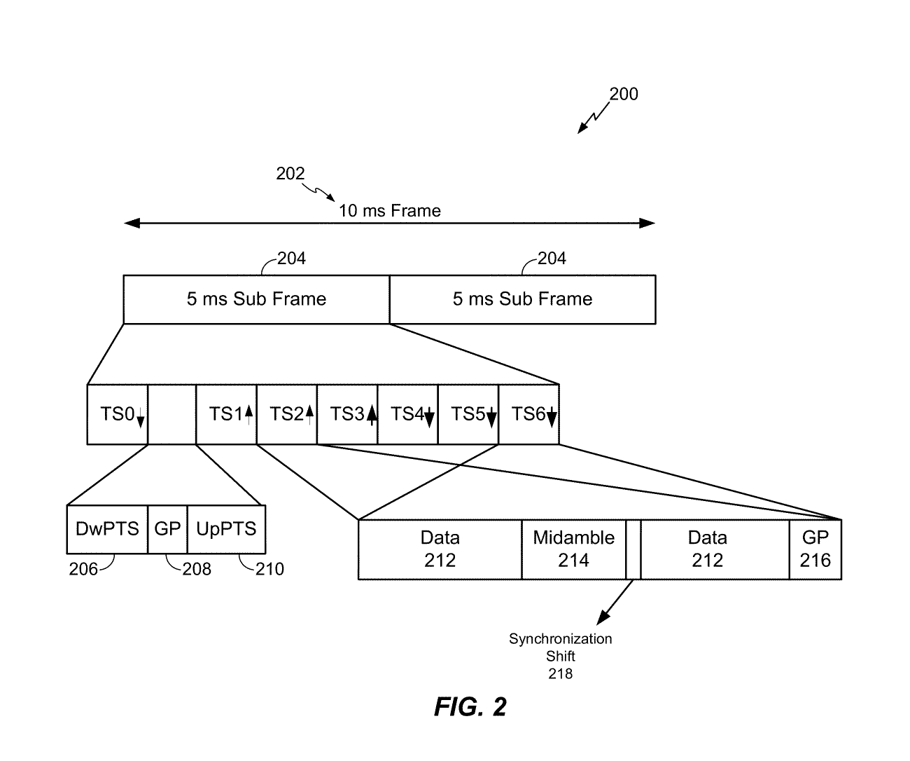

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

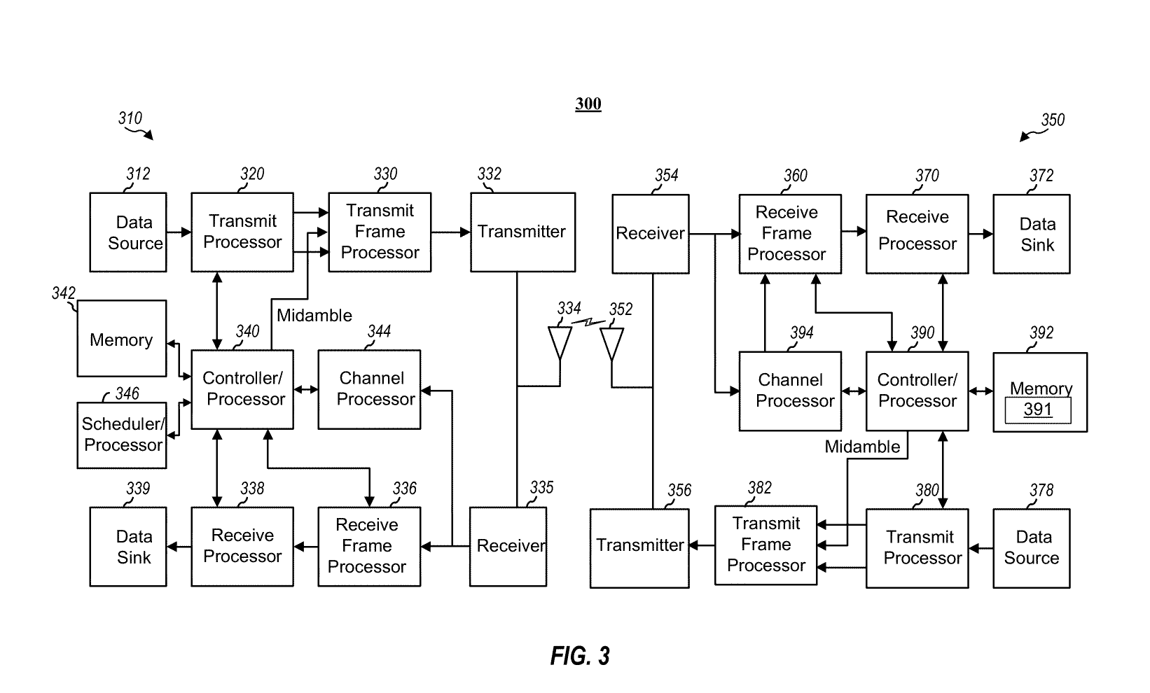

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a measurement reporting module 391 which, when executed by the controller/processor 390, configures the UE 350 to transmit measurement reports based on aspects of the present disclosure. A scheduler/processor 346 at the node B 310 may be used to allocate resources to the UEs and schedule downlink and/or uplink transmissions for the UEs.

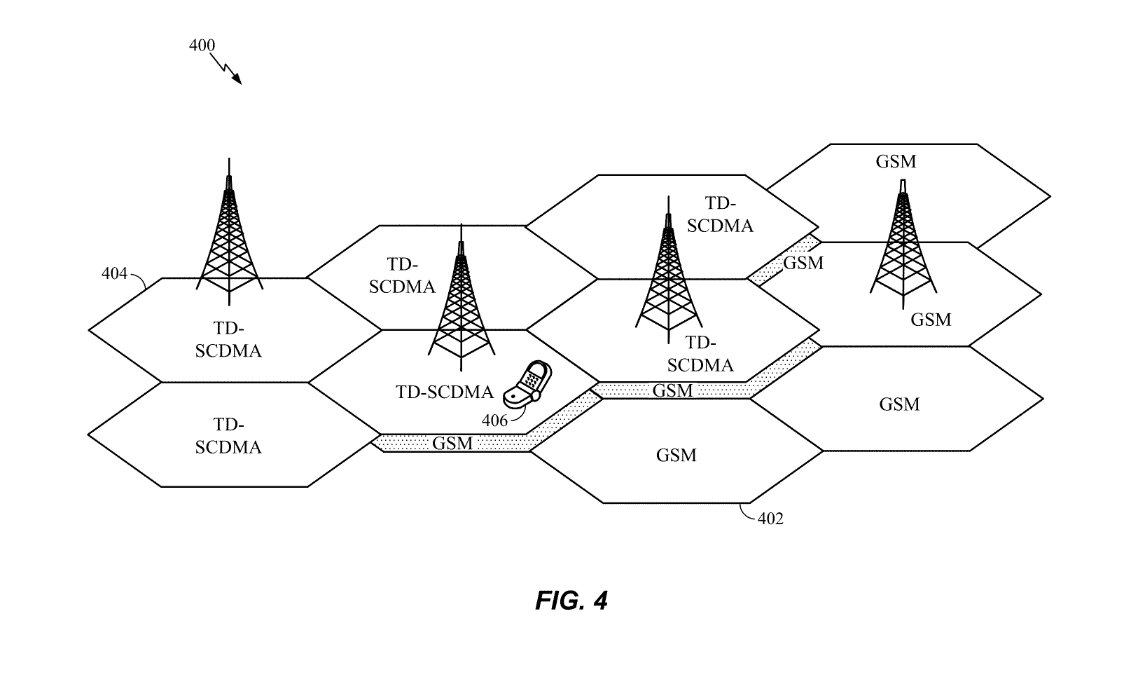

FIG. 4 illustrates coverage of a newly deployed network, such as a TD-SCDMA network and also coverage of a more established network, such as a GSM network. A geographical area 400 may include GSM cells 402 and TD-SCDMA cells 410. A user equipment (UE) 406 may move from one cell, such as a TD-SCDMA cell 404, to another cell, such as a GSM cell 402. The movement of the UE 416 may specify a handover or a cell reselection.

The handover or cell reselection may be performed when the UE moves from a coverage area of a TD-SCDMA cell to the coverage area of a GSM cell, or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Other radio access technologies, such as a wireless local area network (WLAN) (e.g., WiFi) may also be accessed by a user equipment (UE) in addition to cellular networks such as TD-SCDMA or GSM. For the UE to determine nearby WLAN access points (APs), the UE scans available WLAN channels to identify/detect if any WLAN networks exist in the vicinity of the UE. In one configuration, the UE may use TD-SCDMA reception/transmission gaps to switch to the WLAN network to scan the WLAN channels.

Aspects of the disclosure are directed to improving measurement reporting when a weak serving cell is present in a radio access technology (RAT), such as Time Division-Synchronous Code Division Multiple Access (TD-SCDMA).

N-Frequency deployment (also referred to as N-carrier deployment) is a unique way of supporting multiple carriers in TD-SCDMA. Multiple frequencies are used in one TD-SCDMA cell. There may be only one working frequency for an UE at a given time in connected mode.

The carrier that transmits the primary common control physical channel (P-CCPCH) is called the primary frequency and the other carriers are called secondary frequencies. A multi-frequency cell has only one primary frequency. Primary and secondary frequencies in a cell use the same scrambling code and basic midamble. The primary frequency of neighbor cells are typically on different frequencies. The P-CCPCH may be transmitted on Time Slot 0 of the primary frequency.

In the case of multi-frequency cells, handover can occur between: (1) a primary frequency in a serving cell to a primary frequency in a target cell; (2) A primary frequency in a serving cell to a secondary frequency in a target cell; (3) A secondary frequency in a serving cell to a primary frequency in a target cell; and (4) A secondary frequency in a serving cell to a secondary frequency in a target cell.

The network configures both inter and intra frequency neighbor lists. Events, such as 1G and 2A events, can be used to trigger intra and inter frequency reporting, respectively. The measurements and comparison for event triggers are based on the primary frequency in the serving cell for both intra and inter frequency measurements. In case the neighbor cell's signal strength (e.g., P-CCPCH reference signal code power (RSCP)) is above the serving cell's signal strength (e.g., P-CCPCH RSCP) plus some network indicated value (e.g., a hysteresis parameter indicated by a network for the 1G or 2A event), and the condition lasts for a time duration (known as the time to trigger (TTT)), then the UE will then send a measurement report (MR). The measurement report triggers intra or inter frequency handover from the serving cell to the neighbor cell, or another target cell.

When a serving cell (such as a TD-SCDMA serving cell) is weak, inter and intra frequency handover may be triggered. Because inter and intra frequency measurement events are based on the relative signal strength between the serving cell and the neighbor cell, or another target cell, weak inter and intra frequency neighbor cells can trigger handovers. When the UE sends a measurement report for intra/inter frequency handover earlier than an inter radio access technology (IRAT) measurement report (e.g., event 3A), the network sends an inter/intra frequency handover command to respond to the measurement report event (e.g., 1G/2A event). The network ignores the measurement report for the IRAT handover (event 3A). Accordingly, the UE misses the chance for IRAT handover to GSM or another RAT. Thus, the call may be dropped due to the weak serving cell.

According to aspects of the present disclosure, a measurement report for inter/intra frequency handover is transmitted by the UE when the following three conditions are satisfied: (1) when the signal strength of a serving cell of a first RAT (e.g., P-CCPCH RSCP of TD-SCDMA) is lower than a first absolute threshold, (2) the intra and inter frequency neighbor cell signal strength (e.g., P-CCPCH RSCP) of the first RAT is above the serving cell signal strength by a predetermined amount (e.g., P-CCPCH RSCP+a network indicated value (e.g., hysteresis parameter)), and (3) the neighbor cell signal strength is greater than a second absolute threshold (e.g., the neighbor's cell P-CCPCH RSCP is above a second absolute threshold). If all three conditions are satisfied, and the satisfied conditions last for a time duration called the time to trigger (TTT), then the UE will transmit an inter/intra frequency measurement report. Otherwise, the UE will not transmit the inter/intra frequency measurement report. In one configuration, if all three of the conditions are not satisfied, the UE will delay the transmission of the inter/intra frequency measurement report, and transmit an IRAT measurement report first, before transmitting the inter/intra frequency measurement report.

The first absolute threshold and the second absolute threshold may be functions of a signal strength of a target cell of a second RAT, also referred to as the target RAT. For example, if the target cell signal strength increases, then the first absolute threshold may increase by a first amount and the second absolute threshold may increase by a second amount. In one configuration, the first amount and the second amount are the same. In another configuration, the first amount and the second amount are different. The first absolute threshold and the second absolute threshold can also be functions of the threshold settings indicated by the network for the first RAT and the second RAT to trigger an IRAT measurement report.

When the target RAT threshold setting is high, the measurement report may not be delayed for inter/intra frequency handover. That is, the target cell signal strength should be above the target RAT threshold to trigger an IRAT measurement. Thus, a delay naturally occurs even when the target cell signal strength is strong.

According to aspects of the present disclosure, UE handover to weak intra or inter frequency neighbor cells will be prevented when the serving cell is weak. This prevents unnecessary IRAT handover, and may also avoid call drops when served by a weak serving RAT as well.

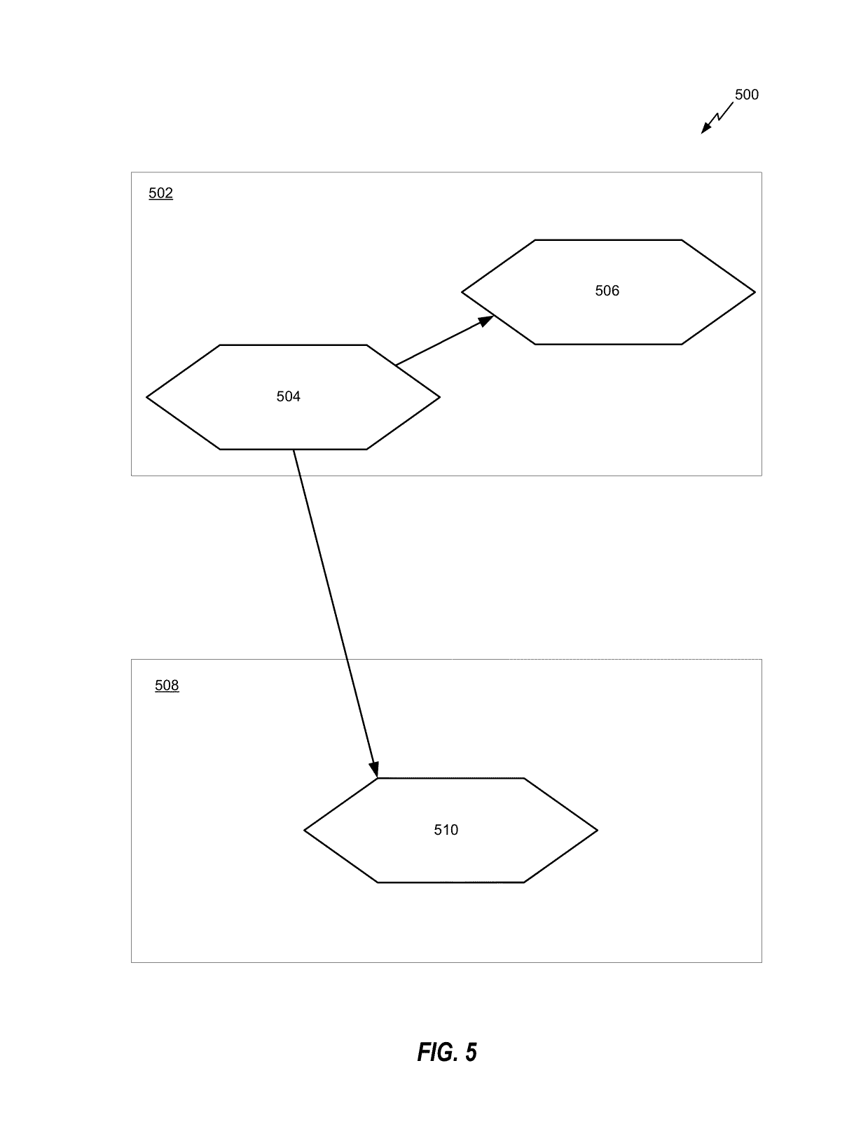

FIG. 5 illustrates a network 500 with multiple RATs having cells. A UE is engaged in communications with RATs such as a first RAT 502 and a second RAT 508. In one configuration, the first RAT 502 is TD-SCDMA and the second RAT 508 is GSM. The UE may perform inter/intra frequency handover between cells of the same RAT, such as between a serving cell 504 to a neighbor cell 506 of the first RAT 502. The neighbor cell 506 may be a neighbor to the serving cell 504 and is also in the first RAT 502. The UE may also perform IRAT handover (or event 3A) between a cell of one RAT (e.g., the serving cell 504 of the first RAT 502) to a cell of another RAT (e.g., a target cell 510 of the second RAT 508). The typical process performs inter/intra frequency handover first, with IRAT handover performed afterwards. A measurement report is transmitted by the UE whenever either inter/intra frequency handover or IRAT handover is to be performed.

According to aspects of the present disclosure, the measurement report transmission may be delayed by increasing the time to trigger (TTT), which is the time elapsed until the handover is performed. For example, the transmission of the measurement report to perform inter/intra frequency handover may be delayed so that the IRAT handover may be performed first.

If an inter/intra frequency handover from the serving cell 504 to the neighbor cell 506 is to be performed, three conditions are to be satisfied. The first condition is that the signal strength or reference signal code power (RSCP) of the serving cell 504 is above a first absolute threshold. The first absolute threshold is so named because it is absolute and does not change in value. The second condition is that the signal strength or RSCP of the neighbor cell 506 is above the signal strength or RSCP of the serving cell 504 by a predetermined first amount. The predetermined first amount may include network indicated values, such as hysteresis parameters. The third condition is that the signal strength or RSCP of the neighbor cell 506 is above a second absolute threshold. Once these three conditions are satisfied for the TTT period, the UE will transmit an inter/intra frequency measurement report to perform inter/intra frequency handover from the serving cell 504 to the neighbor cell 506.

In one configuration, the first absolute threshold and the second absolute threshold are functions of a target cell signal strength, or the signal strength (e.g., RSCP) of the target cell 510 of the second RAT 508. For example, the higher the target cell signal strength value is, the higher the values of the first absolute threshold and the second absolute threshold. The opposite may also be true in that the higher the target cell signal strength value, the lower the first absolute threshold and the second absolute threshold become. In one configuration, the first absolute threshold and the second absolute threshold are functions of the threshold settings received from a network for the first RAT and the second RAT for triggering an IRAT measurement report. The threshold settings of the first RAT and the second RAT may also be set by the network. Depending on various parameters of the threshold settings, the values of the first absolute threshold and the second absolute threshold may be varied.

In one configuration, when the target cell signal strength is above a third absolute threshold, the first absolute threshold is increased by a first amount, and the second absolute threshold is increased by a second amount. In one configuration, the first amount and the second amount are the same. In another configuration, the first amount and the second amount are different. In one configuration, the first amount and the second amount are negative, in that the values are decreased.

In one configuration, the transmission of the measurement report to trigger inter/intra frequency handover may be delayed when the neighbor cell signal strength, or the signal strength of the neighbor cell 506 is below the second absolute threshold. The delaying of the measurement report transmission can be implemented by increasing the TTT value. In one configuration, the amount of increase of the TTT is a function of the target cell signal strength. For example, the TTT is increased more as the target cell signal strength value is greater. The opposite may also be true. In one configuration, the amount of increase of the TTT is a function of the difference between the target cell signal strength and the neighbor cell signal strength. For example, the TTT is increased more as the difference between the target cell signal strength and the neighbor cell signal strength is greater. The opposite may also be true where the TTT is increased less or decreased as the difference between the target cell signal strength and the neighbor cell signal strength becomes greater.

In one configuration, delaying the transmission of the measurement report for inter/intra frequency handover is performed when the target cell signal strength is above a fourth absolute threshold. In one configuration, the fourth absolute threshold is the same as the second absolute threshold. In another configuration, the fourth absolute threshold is different than the second absolute threshold.

In one configuration, delaying the transmission of the measurement report for inter/intra frequency handover is performed when the target cell signal strength is above the serving cell signal strength.

While the transmission of the measurement report for inter/intra frequency handover is being delayed, the measurement report for IRAT handover may be transmitted. This ensures handover to a stronger RAT and prevents inter/intra frequency handover to neighbor cells with a weaker signal strength. This also avoids call drops that result when staying with a weak serving RAT.

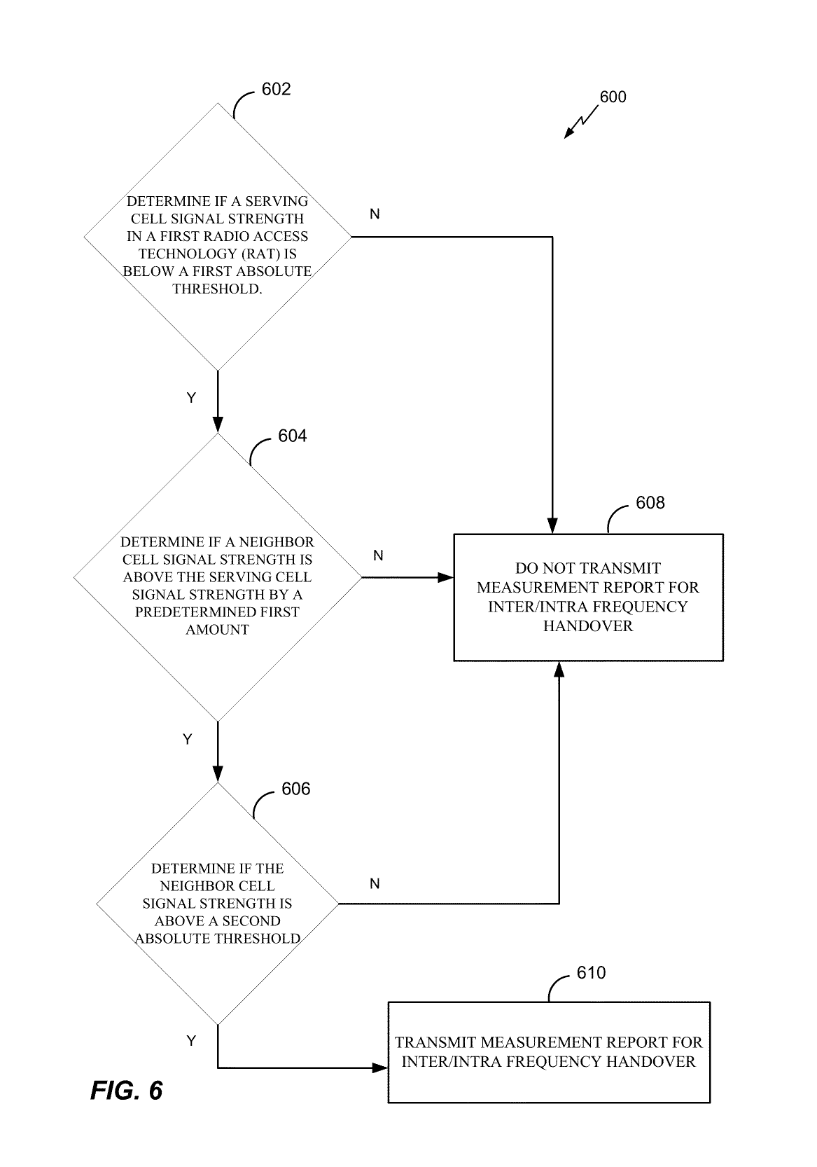

FIG. 6 is a block diagram illustrating a wireless communication method 600 for transmission of measurement reports for inter/intra frequency handover. In block 602, the UE determines if a serving cell signal strength in a first radio access technology (RAT) is below a first absolute threshold. If the answer at block 602 is no, the UE does not transmit the measurement report for inter/intra frequency handover, as shown in block 608. If the answer at block 602 is yes, in block 604, the UE determines if a neighbor cell signal strength, also in the first RAT, is above the serving cell signal strength by a predetermined first amount. If the answer at block 604 is no, the processing at block 608 is performed. If the answer at block 604 is yes, in block 606, the UE determines if the neighbor cell signal strength is above a second absolute threshold. If the answer in block 606 is no, the processing at block 608 is performed. If the answer in block 606 is yes, in block 610, the UE transmits a measurement report for inter/intra frequency handover. In one configuration, the transmission of the measurement report for inter/intra frequency handover may be delayed. In this configuration, the measurement report to trigger IRAT handover may be transmitted before the delayed measurement report for inter/intra frequency handover. In another configuration, the measurement report to trigger IRAT handover may be transmitted after the measurement report for inter/intra frequency handover is transmitted.

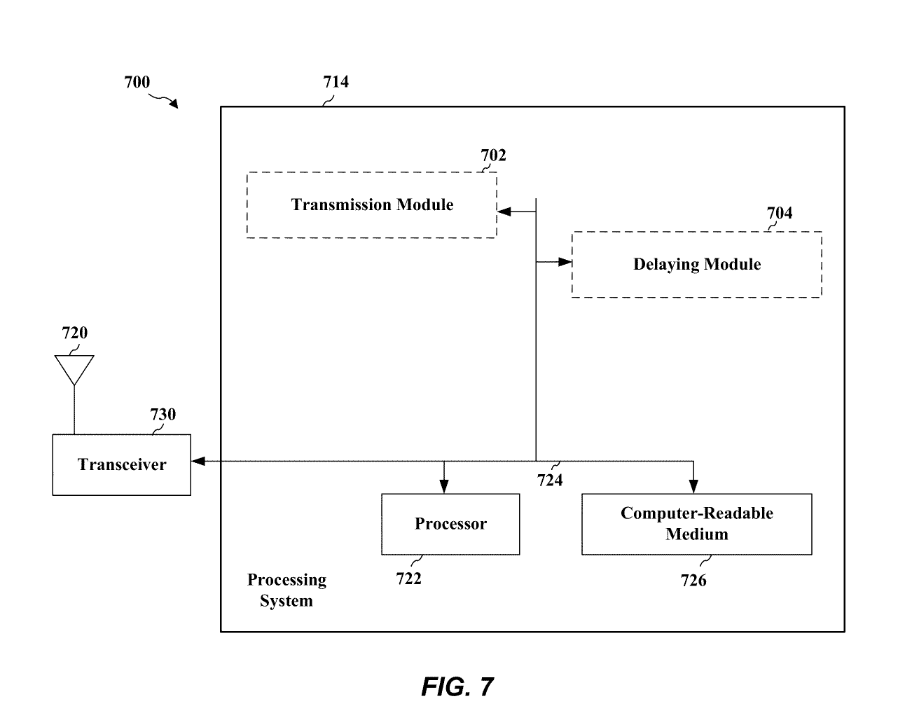

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722, the transmission module 702, the delaying module 704, and the computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a transmission module 702 for transmitting a measurement report for inter/intra frequency handover when certain conditions are met. The first condition is when a serving cell signal strength in a first radio access technology (RAT) is below a first absolute threshold. The second condition is when a neighbor cell signal strength, of a neighbor cell also in the first RAT, is above the serving cell signal strength by a predetermined first amount. The third condition is when the neighbor cell signal strength is above a second absolute threshold. In one configuration, the first absolute threshold and the second absolute threshold are functions of a target cell signal strength of a target cell in a second RAT and functions of threshold settings signaled by a network for the first RAT and the second RAT.

The processing system 714 also includes a delaying module 704 for delaying transmission of the measurement report for inter/intra frequency handover when the neighbor cell signal strength is below the second absolute threshold. The modules may be software modules running in the processor 722, resident/stored in the computer readable medium 726, one or more hardware modules coupled to the processor 722, or some combination thereof. The processing system 714 may be a component of the UE 350 and may include the memory 392, and/or the controller/processor 390.

In one configuration, an apparatus such as an UE 350 is configured for wireless communication including means for transmitting. In one aspect, the above means may be the antennae 352, the transmitter 356, the transmit processor 380, the controller/processor 390, the memory 392, the measurement reporting module 391, the transmission module 702, and/or the processing system 714 configured to perform the functions recited by the aforementioned means. In another aspect, the aforementioned means may be a module or any apparatus configured to perform the functions recited by the aforementioned means.

In one configuration, the apparatus configured for wireless communication also includes means for delaying. In one aspect, the above means may be the antennae 352, the receiver 354, the receive processor 370, the transmitter 356, the transmit processor 380, the controller/processor 390, the memory 392, the measurement reporting module 391, the transmission module 702, and/or the processing system 714 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
transmitting a measurement report for inter/intra frequency handover when:
a serving cell signal strength of a serving cell in a first radio access technology (RAT) is below a first absolute threshold,
a neighbor cell signal strength of a neighbor cell also in the first RAT and a neighbor to the serving cell is above the serving cell signal strength by a predetermined first amount, and
the neighbor cell signal strength is above a second absolute threshold.

2. The method of claim 1, in which the first absolute threshold and the second absolute threshold are functions of a target cell signal strength of a target cell in a second RAT and functions of threshold settings signaled by a network for the first RAT and the second RAT.

3. The method of claim 2, further comprising increasing the first absolute threshold by a first amount and increasing the second absolute threshold by a second amount when the target cell signal strength is above a third absolute threshold.

4. The method of claim 2, further comprising delaying transmission of the measurement report for inter/intra frequency handover when the neighbor cell signal strength is below the second absolute threshold.

5. The method of claim 4, in which delaying comprises increasing a time to trigger for the measurement report for inter/intra frequency handover.

6. The method of claim 5, in which an amount of increase of the time to trigger is a function of the target cell signal strength.

7. The method of claim 6, in which the amount of the time to trigger is increased when there is a greater target cell signal strength.

8. The method of claim 5, in which an amount of increase of the time to trigger is a function of a difference between the target cell signal strength and the neighbor cell signal strength.

9. The method of claim 8, in which the amount of the time to trigger is increased when there is a greater difference between the target cell signal strength and the neighbor cell signal strength.

10. The method of claim 4, in which the delaying is performed when the target cell signal strength is above a fourth absolute threshold and when the target cell signal strength is above the serving cell signal strength by a predetermined second amount.

11. The method of claim 10, in which the fourth absolute threshold is the same as the second absolute threshold.

12. The method of claim 10, further comprising transmitting a measurement report for inter RAT (IRAT) handover before transmitting the measurement report for inter/intra frequency handover.

13. An apparatus for wireless communication, comprising:
means for transmitting a measurement report for inter/intra frequency handover when:
a serving cell signal strength of a serving cell in a first radio access technology (RAT) is below a first absolute threshold,
a neighbor cell signal strength of a neighbor cell also in the first RAT and a neighbor to the serving cell is above the serving cell signal strength by a predetermined first amount, and
the neighbor cell signal strength is above a second absolute threshold; and
means for delaying transmission of the measurement report for inter/intra frequency handover when the neighbor cell signal strength is below the second absolute threshold, in which the first absolute threshold and the second absolute threshold are functions of a target cell signal strength of a target cell in a second RAT and functions of threshold settings signaled by a network for the first RAT and the second RAT.

14. A computer program product for wireless communication in a wireless network, comprising:
a non-transitory computer-readable medium having non-transitory program code recorded thereon, the program code comprising:
program code to transmit a measurement report for inter/intra frequency handover when:
a serving cell signal strength of a serving cell in a first radio access technology (RAT) is below a first absolute threshold,
a neighbor cell signal strength of a neighbor cell also in the first RAT and a neighbor to the serving cell is above the serving cell signal strength by a predetermined first amount, and
the neighbor cell signal strength is above a second absolute threshold; and
program code to delay transmission of the measurement report for inter/intra frequency handover when the neighbor cell signal strength is below the second absolute threshold, in which the first absolute threshold and the second absolute threshold are functions of a target cell signal strength of a target cell in a second RAT and functions of threshold settings signaled by a network for the first RAT and the second RAT.

15. An apparatus for wireless communication, comprising:
a memory; and
at least one processor coupled to the memory, the at least one processor being configured:
to transmit a measurement report for inter/intra frequency handover when:
a serving cell signal strength of a serving cell in a first radio access technology (RAT) is below a first absolute threshold,
a neighbor cell signal strength of a neighbor cell also in the first RAT and a neighbor to the serving cell is above the serving cell signal strength by a predetermined first amount, and
the neighbor cell signal strength is above a second absolute threshold; and
to delay transmission of the measurement report for inter/intra frequency handover when the neighbor cell signal strength is below the second absolute threshold, in which the first absolute threshold and the second absolute threshold are functions of a target cell signal strength of a target cell in a second RAT and functions of threshold settings signaled by a network for the first RAT and the second RAT.

16. The apparatus of claim 15, in which the at least one processor is further configured to increase the first absolute threshold by a first amount and program code to increase the second absolute threshold by a second amount when the target cell signal strength is above a third absolute threshold.

17. The apparatus of claim 15, in which delaying comprises increasing a time to trigger for the measurement report for inter/intra frequency handover.

18. The apparatus of claim 17, in which an amount of increase of the time to trigger is a function of the target cell signal strength.

19. The apparatus of claim 18, in which the amount of the time to trigger is increased when there is a greater target cell signal strength.

20. The apparatus of claim 17, in which an amount of increase of the time to trigger is a function of a difference between the target cell signal strength and the neighbor cell signal strength.

21. The apparatus of claim 20, in which the amount of the time to trigger is increased when there is a greater difference between the target cell signal strength and the neighbor cell signal strength.

22. The apparatus of claim 15, in which the delaying is performed when the target cell signal strength is above a fourth absolute threshold and when the target cell signal strength is above the serving cell signal strength by a predetermined second amount.

23. The apparatus of claim 22, in which the fourth absolute threshold is the same as the second absolute threshold.

24. The apparatus of claim 22, in which the at least one processor is further configured to transmit a measurement report for inter RAT (IRAT) handover before transmitting the measurement report for inter/intra frequency handover.
